(19) United States
(12) Patent Application Publication
(10) Pub. No.: US 2011/0014421 A1
(43) Pub. Date: Jan. 20, 2011

(54) FASTENING OF EDGE STRUCTURE TO SANDWICH STRUCTURE

(76) Inventor: Markku Pietikäinen, Nivala (FI)

Correspondence Address: LADAS & PARRY LLP, 26 WEST 61ST STREET, NEW YORK, NY, 10023, US

(21) Appl. No.: 12/810,148

(22) PCT Filed: Dec. 17, 2008
(86) PCT No.: PCT/FI08/50753

§ 371 Date: Sep. 21, 2010

(30) Foreign Application Priority Data
Dec. 27, 2007 (FI) 20075963

(51) Int. Cl. B32B 3/02; B23P 11/00; B32B 3/10

(52) U.S. Cl. 428/137; 428/192; 29/428

(57) ABSTRACT

In an edge of a sandwich structure a thin sheet is detached for a predetermined portion from a material. A first edge part is placed on one surface of the thin sheet detached from the material. A second edge part is placed on the opposite surface of the thin sheet detached from the material. The thin sheet detached from the material is fastened with a fastening element tightly between the first edge part and the second edge part.

### FIELD

The invention relates to fastening an edge structure to a sandwich structure.

### BACKGROUND

For instance caravan walls and ceilings employ a sandwich structure, in which a porous material acting as thermal insulation is placed between two thin sheets. The porous material may be polyurethane mass, for instance, and the thin sheets may be metal. In the manufacturing stage an opening is cut in the sandwich structure for a window or a door, and in the edges of the opening there is secured a frame to serve as an edge structure such that the edges of the frame press on thin sheets on the opposite sides of the sandwich structure. Additionally, putty is used as sealant.

This solution poses problems, however. The frame may be tightened into place only by using such compression power that the porous material of the sandwich structure withstands without becoming immediately flattened. With time the porous material gives in, however, and its resistance to compression deteriorates, whereby the joint loosens and its sealing capability only relies on the adhesion of the putty serving as a sealing element. The adhesiveness of the putty also deteriorates with time, whereby a path will be created for water to leak through the joint. In current structures leakage water is first migrated into the porous material, and therefore it is not detected until it has caused damage.

Hence, there is a need to develop the interconnection of the frame and the sandwich structure.

### BRIEF DESCRIPTION

The object of the invention is to provide an improved solution for interconnecting an edge structure and a sandwich structure. This is achieved by the fastening of an edge structure to a sandwich structure, where the sandwich structure comprises two thin sheets and a material between the thin sheets. In the edge of the sandwich structure there is at least one thin sheet whose predetermined portion is detached from the material; the edge structure comprises a first edge part and a second edge part, of which the first edge part is arranged for being placed on one surface of the thin sheet detached from the material, and of which the second edge part is arranged for being placed on the opposite surface of the thin sheet detached from the material; and the edge structure comprises a fastening element that is arranged to fasten the thin sheet detached from the material tightly between the first edge part and the second edge part.

The invention also relates to a method for fastening an edge structure to a sandwich structure, where the sandwich structure comprises two thin sheets and a material between the thin sheets. The method further comprises detaching at least a predetermined portion of one thin sheet from the material in the edge of the sandwich structure; placing a first edge part on one surface of the thin sheet detached from the material and placing a second edge part on the opposite side of the thin sheet detached from the material; and fastening the thin sheet detached from the material tightly between the first edge part and the second edge part.

Preferred embodiments of the invention are disclosed in the dependent claims.

Several advantages are achieved with the solution of the invention. The interconnection of the edge structure and the sandwich structure will not transform with time, and consequently the likelihood of leakage reduces.

### LIST OF DRAWINGS

In the following the invention will be described in greater detail in connection with preferred embodiments, with reference to the attached drawings, in which

FIG. 1 shows a prior art interconnection of an edge structure and a sandwich structure,

FIG. 2 shows fastening of an edge structure to a thin sheet of a sandwich structure,

FIG. 3 shows fastening of an edge structure to a thin sheet of a sandwich structure,

FIG. 4 shows a protective part,

FIG. 5 shows openings in the sandwich structure,

FIG. 6 shows frames placed in the sandwich structure,

FIG. 7 shows interconnection of two sandwich structures at a straight angle,

FIGS. 8A and 8B show interconnection of two sandwich structures at a right angle and

FIG. 9 shows a flow chart of the method.

### DESCRIPTION OF EMBODIMENTS

Let us first examine a prior art solution by means of FIG. 1. A sandwich structure 100 comprises two thin sheets 102, 104 and a material 106, which is polyurethane for instance, between the thin sheets 102, 104. The material 106 may be porous. The thin sheets 102, 104 may be plastic, metal or glass fibre, for instance. The thin sheet 102 is on the side where the sandwich structure 100 is exposed to environmental effects. Of the environmental effects particularly variations in the temperature and water may cause problems. In the edge 114 of the sandwich structure 100 there is secured an edge structure 108 that comprises a first fastening part 110 and a second fastening part 112. The fastening parts 110, 112 are made to press the sandwich structure 100 by means of a fastening part 116, which may be a screw, for instance. The tightening force between the fastening parts 110, 112 may amount at most to what the porous material 106 of the structure withstands.

The joint between the edge structure 108 and the sandwich structure 100 may further be sealed with putty 118, which may be butyl paste, for instance. The compression in the joint, however, makes the porous material 106 yield in time as the compression capability deteriorates, whereby the thin sheets 102, 104 will also give in. As a result, the sealing capability of the joint deteriorates and the putty 118 will be detached from its base. The final result is that water leaks in at points where the putty 118 is detached and may be absorbed in the porous material 106. The outdoor air and temperature may also penetrate the joint. Thus, water leaks in the space confined by the sandwich structure 100 and inside the material 106 both directly and through condensation. This cannot be detected until the materials have been damaged through moulding, for instance.

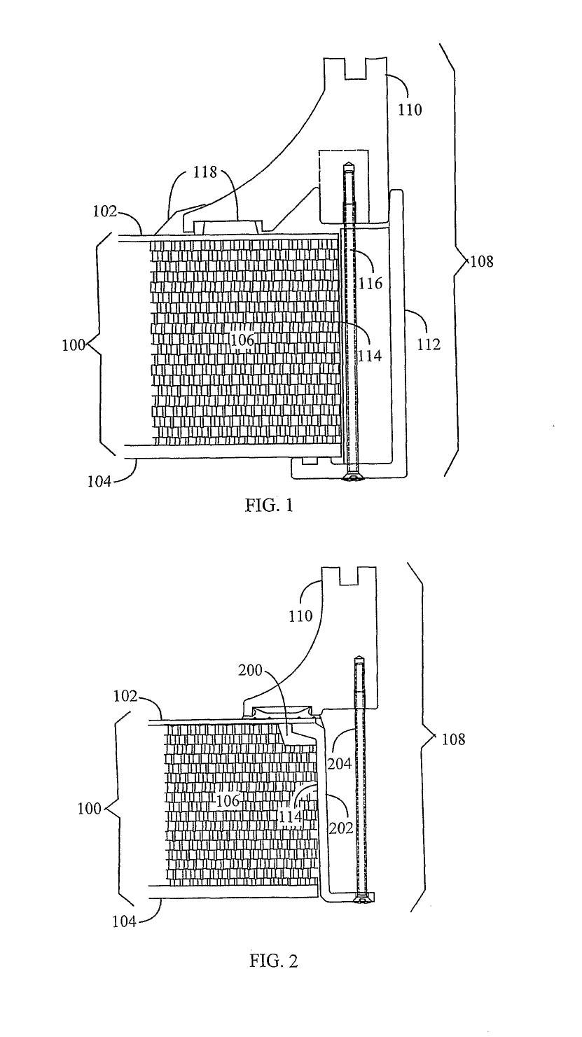

FIG. 2 shows a solution, in which the compression of the edge structure 108 is directed to a thin sheet 102, instead of the sandwich structure 100. In an edge 114 of the sandwich structure 100 the thin sheet 102 is detached from the porous material 106, which may serve as thermal insulation, for instance, by removing a predetermined portion 200 of the porous material. The edge structure 108 comprises a first edge part 110 and a second edge part 202, of which the first edge part 110 is placed on one surface of the thin sheet 102 detached from the porous material 106, and of which the second edge part 202 is placed on the opposite surface of the thin sheet 102 detached from the porous material 106. In addition, the edge structure 108 comprises a fastening element 204, which is arranged to fasten the thin sheet 102 detached from the porous material 106 tightly between the first edge part 110 and the second edge part 202. The fastening element 204 may be a screw, for instance, and in that case the second edge part 202 may be provided with a hole for the screw and the screw is driven in the first edge part 110. By means of the screw the fastening tightness may be adjusted as desired. The fastening with a screw allows the fastening tightness to remain unchanged in relation to time. The tightness of the screw may be readily monitored and it is possible to increase or decrease the tightness of the screw if found necessary. The second edge part 202 may be so long that it protects the porous material 106 in the edge 114, and the second edge part 202 may be slightly z-shaped in cross section.

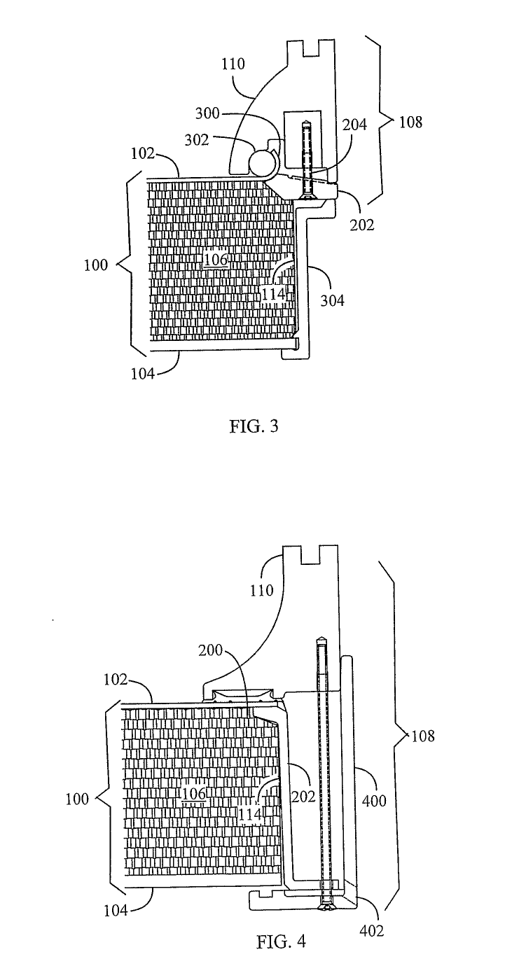

FIG. 3 shows an embodiment, in which an end part 300 of the thin sheet 102 that is exposed to environmental effects is shaped into a collar. In comparison with the previous solution this one is added with bending the end part 300 outwardly for the collar with an appropriate device. If the thin sheet 102 is of metal, such as sheet metal, the collar is relatively easy to make. In this case the planar sealing solution of the prior art may be replaced by a sealing base, which is created by bending the edge of the opening either outwardly or inwardly. As the first edge part 110 and the second edge part 202 are tightened towards one another with the fastening element 204, it is possible to use between the first edge part 110 and the second edge part 202 a seal 302 that is arranged to press tightly against both edge parts 110, 202. The seal 302 may be a profiled rubber seal that may be made of a band in situ or it may be made to be supplied with each frame or collar.

The outwardly bent collar in the thin sheet 102 is particularly well suited for through holes to be made in ceilings, such as skylight windows, lead-ins for air conditioners, ventilation ducts and lead-ins for electric wires and water pipes. The solution may also be used for securing various accessories and details, such as handles, in the body.

Together with the frame of the edge structure the bent collar forms a sealing base for the seal 302 and at the same time a mechanical threshold against accessing water into the sandwich structure.

The seal 302 is not necessarily needed, but the first edge part 110 may have been designed to have the same shape as the end part 300, whereby it will press well against the end part 300. Likewise, the second edge part 202 may have been designed to match the shape of the bent end part 300. Even though in this solution it is not necessary to remove porous material 106, the end part 300 may extend beyond the porous material 106 at the edge 114 thus separating from the porous material 106.

As shown in FIG. 3, a protective part 304 may be attached at the edge 114 to protect the porous material 106. The protective part 304 may be attached by pressing it on the thin sheet 104 or by using a screw, for instance. The protective part 304 prevents access of moisture into the material 106.

Instead of what is shown in FIG. 3, it is possible to bend the end part 300 also inwardly. In that case the second edge part 202 may be shaped inwardly, i.e. curving towards the porous material 106, and the first edge part 110 may be shaped to serve as a counterpart to this shape. The inwardly bent structure is suited for leisure vehicles, campers, animal trailers, building site sheds, sales vehicles and other spaces of multilayer vehicle structures, as well as for openings, windows, doors, hatches and ventilating holes in their side walls. This structure does not increase the thickness of the edge structure significantly. Sealing may be performed with a profiled rubber seal also in this solution. As an additional protection, the solution may employ a “weather guard groove” which guides main part of rainwater past the actual seal. Namely, the water in the vicinity of the seal may freeze, especially in northern conditions, and ice may press the seal and/or expand the edge structure such that water may leak in past the seal.

FIG. 4 shows a solution similar to that in FIG. 2, to which is added a protective part 400. The protective part 400 may be fastened with the same fastening element 204, wherewith the first edge part 110 and the second edge part 202 are interconnected. The protective part 400 may cover completely the edge 114, the second edge part 202 and almost completely the screw serving as the fastening element 204. The lower part of the protective part 400 may comprise a hole 402, which serves as an indicator hole such that it indicates a moisture problem by letting water out. Thus, if leakage occurs against all odds, it will be immediately visible, and water has no access to the material 106.

FIGS. 2 to 4 show, how the thin sheet 102 is pressed between the first edge structure 110 and the second edge structure 202. In the same manner the edge structures may also be fastened to the thin sheet 104.

FIG. 5 shows a wall made of the sandwich structure 100 and comprising two openings 500, 502. The openings may be intended for doors, windows, ventilation or other installations penetrating the structure. Both openings 500, 502 have edges 504, 506 which are equal to the edge 114 in FIGS. 2 to 4. Instead of the wall, the sandwich structure 100 of FIG. 5 with openings 500, 502 may show a ceiling, for instance.

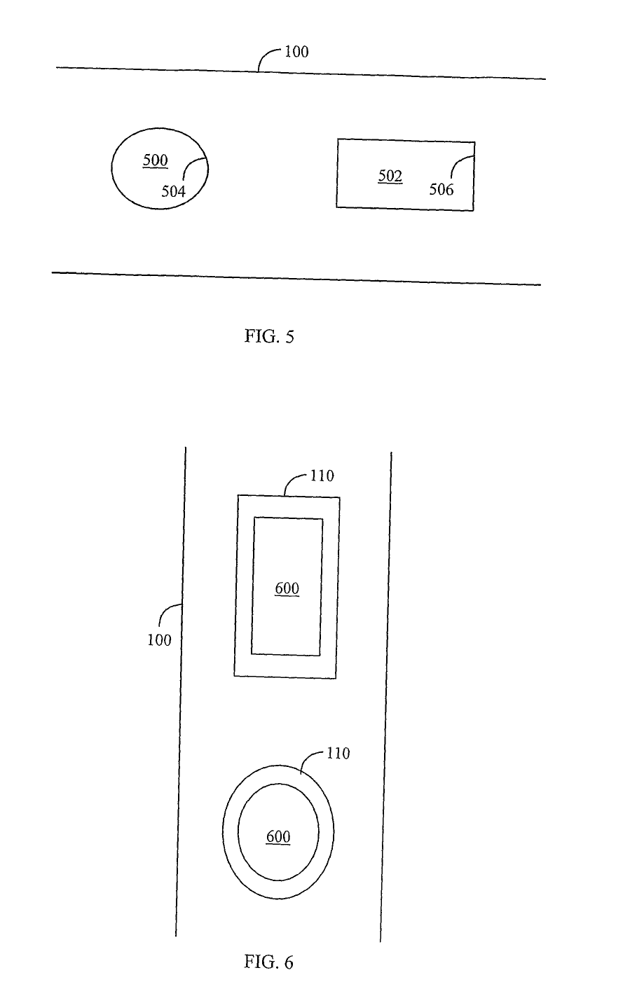

FIG. 6 shows a wall or a ceiling made of the sandwich structure 100 of FIG. 5, in the openings 500, 502 of which there is placed a first edge structure 110. The edge structure 110 may be a window frame 600, for instance. Instead of the window 600, the edge structure 110 may serve as a frame of a door or a hatch.

The presented solution changes only slightly the current inlet opening formation and installation. The opening 500, 502 may be cut like before using a foxtail saw or the like. The dimensions of the opening are the same as before. The objective is to enable retrofitting. From inside the opening it is possible to remove some material 106 (in FIG. 4 removed part 200).

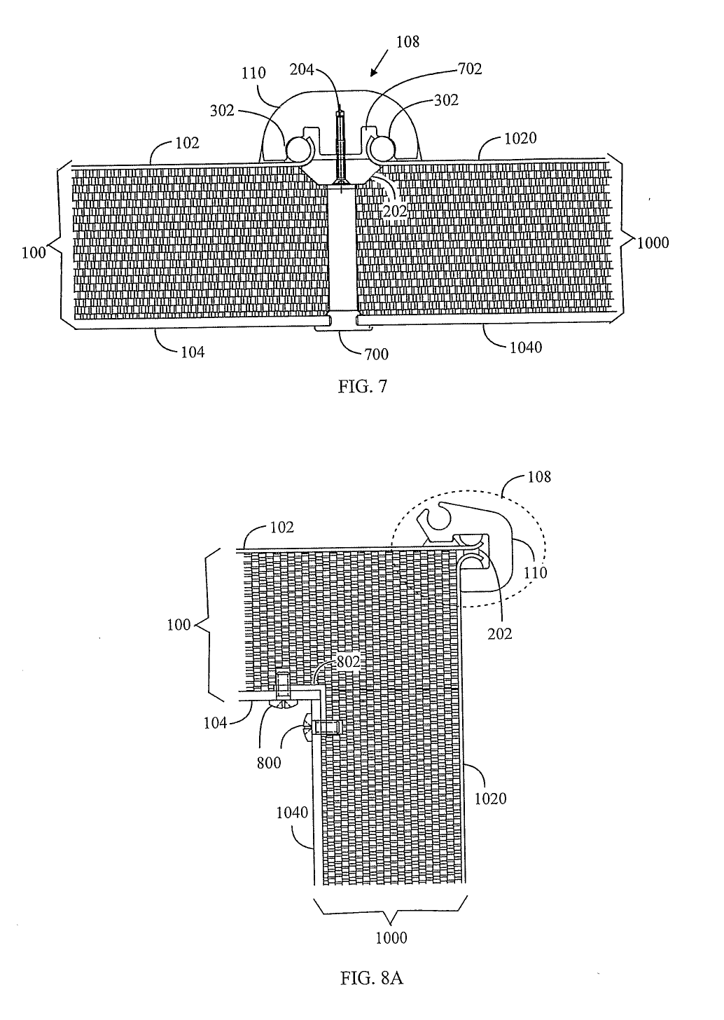

FIG. 7 shows a solution, in which two sandwich structures 100, 1000 have been interconnected by means of an edge structure 108. On the surface of the sandwich structures 100, 1000 there are thin sheets 104, 1040. In this solution the sandwich structures 100, 1000 are at a straight angle to one another. The edge structure 108 comprises a first edge part 110 and a second edge part 202. The edge parts 110, 202 are pressed towards one another with a fastening element 204 such that the thin sheets 102, 1020 remain tightly therebetween. A seal 302 may be included in the fastening in the same way as in the case of FIG. 3. In addition, the gap between the sandwich structures 100, 1000 may be blocked with a sealing part 700, which may be a wooden, plastic or metal piece, for instance. Between the edge parts 110, 202 there is a passage 702 for leakage water, if any. The water that may have accessed the passage, can be led controllably out of the structures from at least one end of the joint.

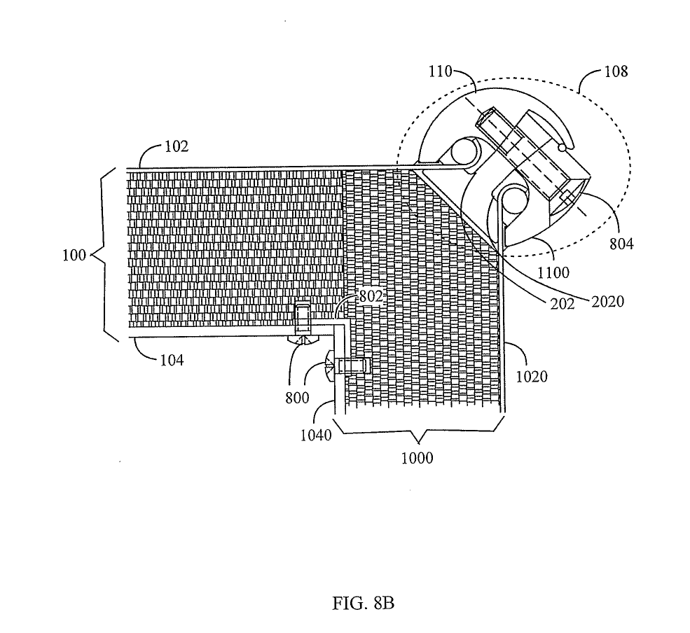

FIG. 8A also shows a solution, in which two sandwich structures 100, 1000 have been interconnected by means of an edge structure 108. In this solution the sandwich structures 100, 1000 are at a right angle to one another. The edge structure 108 comprises a first edge part 110 and a second edge part 202. The edge parts 110, 202 may be pressed towards one another by means of the edge part 110 such that the thin sheets 102, 1020 remain tightly therebetween. The sandwich structures 100, 1000 may be fastened to one another, for instance, by means of screws 800 and a counterpart 802, into which the screws 800 are driven. The screws 800 and the counterpart 802 thereof are located on the opposite sides of the thin sheets 104, 1040.

Further, FIG. 8B shows a solution, in which two sandwich structures 100, 1000 are interconnected by means of an edge structure 108. In this solution as well the sandwich structures 100, 1000 are at a right angle to one another. The edge structure 108 comprises a first edge part 110, a second edge part 202, a third edge part 1100 and a fourth edge part 2020. The edge parts 110, 202 may be pressed towards one another by means of a fastening element 804 such that the thin sheet 102 remains tightly therebetween. Likewise, the edge parts 1100, 2020 may be pressed towards one another by means of fastening element 804 such that the thin sheet 1020 remains tightly therebetween. The fastening element 804 may be a screw, for instance. The sandwich structures 100, 1000 may be interconnected, for instance, by means of screws 800 and a counterpart 802, into which the screws 800 are driven. The screws 800 and the counterpart 802 thereof are located on the opposite sides of the thin sheets 104, 1040.

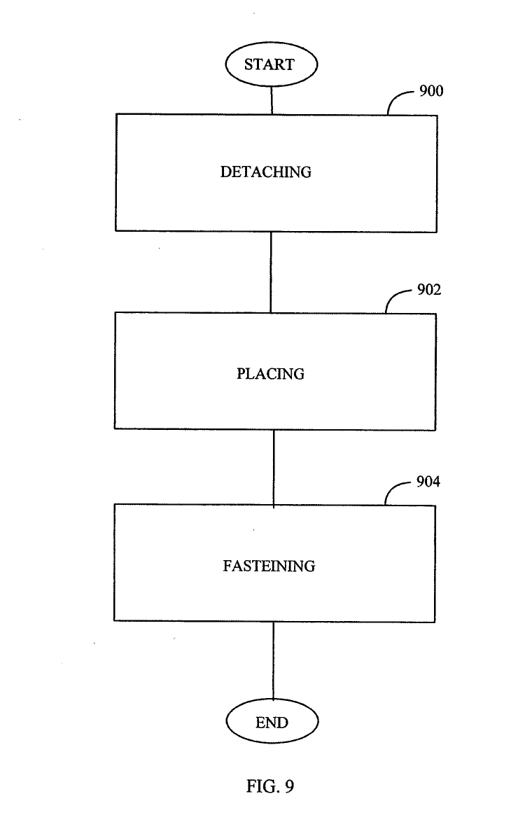

FIG. 9 shows a method for fastening an edge structure to a sandwich structure. In step 900 at least one thin sheet is detached for a predetermined portion 116 in the edge 504, 506 of the sandwich structure 100 from porous material 106. In step 902 a first edge part 110 is placed on one surface of the thin sheet 102, 104 detached from the porous material 106 and a second edge part 202 is placed on the opposite surface of the thin sheet 102, 104 detached from the porous material 106. In step 904 the thin sheet 102, 104 detached from the porous material 106 is fastened tightly between the first edge part 110 and the second edge part 202.

The presented solution benefits the end user, because the fastening to the thin sheet retains its tightening torque. The solution is weatherresistant and putty is not necessarily needed at any stage. A further benefit to the end user is the fact that the investment (e.g. caravan) retains its value and the safety in service is improved. In addition, the sandwich structure may be assembled without disruptions, because a door or a window need not be installed in the planar direction of the sandwich structure. The first edge part 110 and the second edge part 202 to be fastened to the sandwich structures may be manufactured separately with respect to one another and to the sandwich structure 100. The first edge part 110 and the second edge part 202 need not be fastened to the sandwich structures 100 at the manufacturing stage of the edge parts, but only at the installation stage of a door or a window.

For the manufacturer the structure provides competitive advantage. Reliability of the through hole is of interest to the client, and consequently a better price is obtainable. In addition, non-use of putty shortens production turnaround time, which in turn reduces manufacturing costs and releases working capital. Moreover, as the product meets better the client's demands and the guarantee costs are lower, the manufacturer will have advantage.

For the manufacturers of through holes the presented solution provides new opportunities on the retrofitting market.

Even though the invention is described above with reference to the examples of the attached drawings, it is apparent that the invention is not restricted thereto, but it may be modified in a variety of ways within the scope of the attached claims.

1. Fastening of an edge structure to a sandwich structure, wherein the sandwich structure comprises two thin sheets and a material between the thin sheets,
in the edge of the sandwich structure there is at least one thin sheet whose predetermined portion is detached from the material;
the edge structure comprises a first edge part and a second edge part, of which the first edge part is configured for being placed on one surface of the thin sheet detached from the material, and of which the second edge part is configured for being placed on the opposite surface of the thin sheet detached from the material; and
the edge structure comprises a fastening element that is configured to fasten the thin sheet detached from the material tightly between the first edge part and the second edge part.

2. The edge structure of claim 1, wherein the edge structure is a frame that is configured for being placed in the edge of an opening in the sandwich structure.

3. The edge structure of claim 2, wherein the frame is a door frame.

4. The edge structure of claim 2, wherein the frame is a window frame.

5. The edge structure of claim 1, wherein the edge structure is a joint structure that is configured to fasten two sandwich structures to one another.

6. The edge structure of claim 5, wherein the joint structure is configured to interconnect two sandwich structures that are at an angle other than straight angle to one another.

7. The edge structure of claim 1, wherein the edge structure comprises a protective part that is configured to cover at least one thin sheet and material in the edge of the sandwich structure.

8. The edge structure of claim 7, wherein the protective part comprises a hole for detecting water.

9. The edge structure of claim 1, wherein a passage is placed between the edge parts for leakage water.

10. A method for fastening an edge structure to a sandwich structure, the method comprising
Detaching at least one thin sheet for a predetermined portion from the material in the edge of the sandwich structure, the sandwich structure comprising two thin sheets and a material between the thin sheets;
placing a first edge part on one surface of the thin sheet detached from the material and placing a second edge part on the opposite surface of the thin sheet detached from the material; and
fastening the thin sheet detached from the material tightly between the first edge part and the second edge part.

11. The method of claim 10, the method further comprising placing a frame serving as the edge structure in the edge of an opening in the sandwich structure.

12. The method of claim 11, wherein the frame is a door frame.

13. The method of claim 11, wherein the frame is a window frame.

14. The method of claim 10, the method further comprising interconnecting two sandwich structures with a joint structure serving as the edge structure.

15. The method of claim 14, the method further comprising interconnecting two sandwich structures, which are at an angle other than a straight angle to one another, with a joint structure serving as the edge structure.

16. The method of claim 10, the method further comprising covering at least one thin sheet and the material in the edge of the sandwich structure with a protective part.

17. The method of claim 16, the method further comprising forming a hole in the protective part for detecting leaked or condensed water.

18. The method of claim 10, the method further comprising forming a passage for leakage water between the edge parts.
